(19) United States
(12) Patent Application Publication
(10) Pub. No.: US 2014/0222520 A1
(43) Pub. Date: Aug. 7, 2014

(54) MANAGING CUSTOMER CHANGE REQUESTS

(71) Applicants: Aditya Karanth, Manipal (IN); Vikram Khatri, Bangalore (IN); Shreevathsa S., Bangalore (IN)

(72) Inventors: Aditya Karanth, Manipal (IN); Vikram Khatri, Bangalore (IN); Shreevathsa S., Bangalore (IN)

(73) Assignee: SAP AG

(21) Appl. No.: 13/758,165

(22) Filed: Feb. 4, 2013

(51) Int. Cl. G06Q 10/06

(52) U.S. Cl. CPC G06Q 10/0637
USPC 705/7.36

(57) ABSTRACT

Techniques for managing customer change requests include receiving a change request associated with a business project of a business enterprise, the change request including one or more parameters; comparing the one or more parameters with one or more business rules associated with the business enterprise; based on the comparison, determining that at least one of the one or more of the parameters satisfies at least one of the one or more business rules; in response to the determination, generating one or more requests for approval for the change request; receiving one or more approval responses from one or more entities associated with the business enterprise in response to the one or more requests for approval; and in response to receiving the one or more approval responses, updating a property associated with the business project.

### TECHNICAL BACKGROUND

This disclosure relates to customer change requests and, more particularly, managing customer change requests associated with a business project.

### BACKGROUND

The management of customer change requests requires different business processes which need to be adjusted depending on the business context or the business situation associated with the business process. For example, during product development phase and product launch, the product may undergo changes, enhancements and bug fixes. Tracking of these changes may be a crucial task for businesses.

### SUMMARY

The present disclosure relates to computer-implemented methods, software, and systems for managing customer change requests. In some implementations, a change request associated with a business project of a business enterprise is received. In some examples, the change request including one or more parameters. The one or more parameters are compared with one or more business rules associated with the business enterprise. Based on the comparison, it is determined that at least one of the one or more of the parameters satisfies at least one of the one or more business rules. In response to the determination, one or more requests are generated for approval for the change request. In some implementations, one or more approval responses are received from one or more entities associated with the business enterprise in response to the one or more requests for approval. In response to receiving the one or more approval responses, a property is updated that is associated with the business project.

Other general implementations include corresponding computer systems, apparatus, and computer programs recorded on one or more computer storage devices, each configured to perform the actions of the methods. A system of one or more computers can be configured to perform operations to perform the actions. One or more computer programs can be configured to perform particular operations or actions by virtue of including instructions that, when executed by data processing apparatus, cause the apparatus to perform the actions.

In a first aspect combinable with any of the general implementations, the business enterprise is a first business enterprise, and the first aspect further includes determining a status of an approval of the change request from one or more entities associated with a second business enterprise that is different than the first business enterprise.

A second aspect combinable with any of the previous aspects further includes, based on determining that the status indicates that the approval is required, generating one or more additional requests for approval for the change request.

A third aspect combinable with any of the previous aspects further includes receiving one or more additional approval responses from one or more entities associated with the second business enterprise in response to the one or more additional requests for approval.

A fourth aspect combinable with any of the previous aspects further includes, in response to receiving the one or more additional approval responses, updating the property associated with the business project.

In a fifth aspect combinable with any of the previous aspects, the one or more parameters include margin percentage, change request amount, and project status.

A sixth aspect combinable with any of the previous aspects further includes identifying one or more roles based on the comparison, the roles associated with the business enterprise.

A seventh aspect combinable with any of the previous aspects further includes identifying the one or more entities associated with the one or more roles.

An eighth aspect combinable with any of the previous aspects further includes providing the one or more requests for approval to the one or more entities.

A ninth aspect combinable with any of the previous aspects further includes determining a status of an approval of the change request.

A tenth aspect combinable with any of the previous aspects further includes, in response to determining that the status indicates that the approval is required, comparing the one or more parameters with one or more business rules associated with the business enterprise.

An eleventh aspect combinable with any of the previous aspects includes determining a state of the change request.

A twelfth aspect combinable with any of the previous aspects includes, in response to determining the state of the change request, performing at least one of: determining the status of the approval of the change request based on a determination that the change request is satisfactory; or adjusting the change request based on a determination that the change request is unsatisfactory.

In a thirteenth aspect combinable with any of the previous aspects, the property includes a monetary budget associated with the business project.

Various implementations of a computing system according to the present disclosure may have one or more of the following features. For example, a feature can include the automation of cost approval of business projects. Additionally, the handling of change requests could be automated. For example, various dates for tracking (e.g., resolution date) can be entered into the change request based on a contract signed with the customer; the most appropriate responsible persons could be identified for performing tasks which lead to the completion of the change request; and subsequent business processes like an update of business documents could be triggered based on the context after the cost approval. All these determinations can be categorized and performed based on a type of the change request, for example—customer change request, internal change request, contract change, etc.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 illustrates an example distributed computing system for managing customer change requests;

FIG. 2 is a flowchart of an example method for managing customer change requests;

FIGS. 3A-3C are example graphical user interfaces for managing customer change requests;

FIG. 4 is a flow chart of an example method for managing customer change requests;

FIG. 5 illustrates an example approval matrix associated with a business project;

FIG. 6 is a flowchart of an example method of managing external approval of customer change requests; and

FIG. 7 is a flowchart of an example method of generating requests for approval.

### DETAILED DESCRIPTION

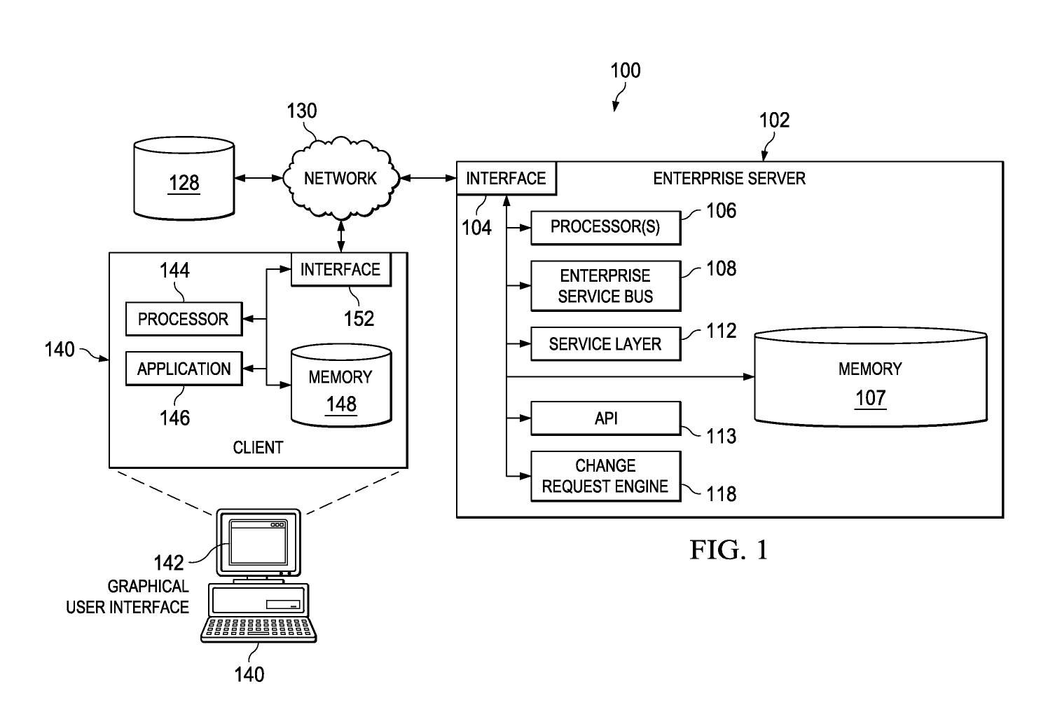

FIG. 1 illustrates an example distributed computing system 100 for managing customer change requests. For example, the illustrated distributed computing system 100 includes or is communicably coupled with an enterprise server computing system 102, a client computing system 140, and a repository 128, at least some of which communicate across a network 130. In general, the enterprise server computing system 102 is any server that stores one or more hosted applications, such as for example, a change request engine 118, where at least a portion of the hosted applications are executed via requests and responses sent to users or clients within and communicably coupled to the illustrated distributed computing system 100 of FIG. 1.

In some aspects, the computing system 100 receives a change request associated with a business project of a business enterprise. In some examples, the change request can include an adjustment to a business project (e.g., a construction project). The adjustment can result in an increase to a monetary budget associated with the business project, and the timing of completion of the business project. In some aspects, parameters of the change request are compared with business rules and it is determined whether the parameters satisfy one or more of the business rules. When the parameters satisfy one or more of the business results, requests for approval are generated for the change request. In some examples, the request for approval can be provided to persons internal to the business enterprise associated with the business project, and/or persons external to the business enterprise. In response to receiving approval requests (e.g., an “approval”), a property (e.g., monetary budget, time budget) that is associated with the business project is updated.

In some examples, the illustrated enterprise server computing system 102 may store a plurality of various hosted applications, while in some examples, the enterprise server computing system 102 may be a dedicated server meant to store and execute only a single hosted application. In some instances, the enterprise server computing system 102 may comprise a web server, where the hosted applications represent one or more web-based applications accessed and executed via the network 130 by the client computing system 140 to perform the programmed tasks or operations of the hosted application.

At a high level, the illustrated enterprise server computing system 102 comprises an electronic computing device operable to receive, transmit, process, store, or manage data and information associated with the distributed computing system 100. Specifically, the enterprise server computing system 102 illustrated in FIG. 1 is responsible for receiving application requests from one or more client applications associated with the client computing system 140 of the distributed computing system 100 and responding to the received requests by processing said requests in the associated hosted application, and sending the appropriate response from the hosted application back to the requesting client application. In addition to requests from the client computing system 140 illustrated in FIG. 1, requests associated with the hosted applications may also be sent from internal users, external or third-party customers, other automated applications, as well as any other appropriate entities, individuals, systems, or computers.

As used in the present disclosure, the term “computer” is intended to encompass any suitable processing device. For example, although FIG. 1 illustrates a single enterprise server computing system 102, the distributed computing system 100 can be implemented using two or more servers, as well as computers other than servers, including a server pool. In some examples, the enterprise server computing system 102 may be any computer or processing device such as, for example, a blade server, general-purpose personal computer (PC), Macintosh, workstation, UNIX-based workstation, or any other suitable device. In other words, the present disclosure contemplates computers other than general purpose computers, as well as computers without conventional operating systems. Further, the enterprise server computing system 102 may be adapted to execute any operating system, including Linux, UNIX, Windows, Mac OS, or any other suitable operating system.

As mentioned above, the illustrated enterprise server computing system 102 includes a change request engine 118. At a high level, in some aspects, the change request engine 118 receives a change request associated with a business project of a business enterprise. In some examples, the change request can include an adjustment to a business project (e.g., a construction project). The adjustment can result in an increase to a monetary budget associated with the business project, and the timing of completion of the business project. The change request engine 118, in some aspects, compares parameters of the change request (e.g., margin percentage, change request amount, project status) with business rules and determines whether the parameters satisfy one or more of the business rules. When the parameters satisfy one or more of the business results, the change request engine 118 generates requests for approval for the change request. In some examples, the requests for approval can be provided to project managers and management personal associated with the business project. In some examples, the request for approval can be provided to persons internal to the business enterprise associated with the business project, and/or persons external to the business enterprise. In response to receiving approval requests (e.g., an “approval”), the change request engine 118 updates a property (e.g., monetary budget, time budget) associated with the business project.

The illustrated enterprise server computing system 102 further includes an interface 104. Although illustrated as a single interface 104 in FIG. 1, two or more interfaces 104 may be used according to particular needs, desires, or particular implementations of the example distributed computing system 100. The interface 104 is used by the enterprise server computing system 102 for communicating with other systems in a distributed environment—including within the example distributed computing system 100—connected to the network 130; for example, the client computing system 140 as well as other systems communicably coupled to the network 130 (not illustrated). Generally, the interface 104 comprises logic encoded in software and/or hardware in a suitable combination and operable to communicate with the network 130. More specifically, the interface 104 may comprise software supporting one or more communication protocols associated with communications such that the network 130 or interface's hardware is operable to communicate physical signals within and outside of the illustrated example distributed computing system 100.

Regardless of the particular implementation, “software” may include computer-readable instructions, firmware, wired or programmed hardware, or any combination thereof on a tangible medium (transitory or non-transitory, as appropriate) operable when executed to perform at least the processes and operations described herein. Indeed, each software component may be fully or partially written or described in any appropriate computer language including C, C++, Java, Visual Basic, ABAP, assembler, Perl, any suitable version of 4GL, as well as others. While portions of the software illustrated in FIG. 1 are shown as individual modules that implement the various features and functionality through various objects, methods, or other processes, the software may instead include a number of sub-modules, third party services, components, libraries, and such, as appropriate. Conversely, the features and functionality of various components can be combined into single components as appropriate.

The illustrated enterprise server computing system 102 further includes a processor 106. Although illustrated as a single processor 106 in FIG. 1, two or more processors may be used according to particular needs, desires, or particular implementations of the example distributed computing system 100. The processor 106 may be a central processing unit (CPU), a blade, an application specific integrated circuit (ASIC), a field-programmable gate array (FPGA), or another suitable component. Generally, the processor 106 executes instructions and manipulates data to perform the operations of the enterprise server computing system 102. Specifically, the processor 106 executes the functionality required to receive and respond to requests from the client computing system 140.

The illustrated enterprise server computing system 102 also includes a memory 107. Although illustrated as a single memory 107 in FIG. 1, two or more memories may be used according to particular needs, desires, or particular implementations of the example distributed computing system 100. While memory 107 is illustrated as an integral component of the enterprise server computing system 102, in some implementations, the memory 107 can be external to the enterprise server computing system 102 and/or the example distributed computing system 100. The memory 107 may include any memory or database module and may take the form of volatile or non-volatile memory including, without limitation, magnetic media, optical media, random access memory (RAM), read-only memory (ROM), removable media, or any other suitable local or remote memory component. The memory 107 may store various objects or data, including classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the enterprise computing system 102. Additionally, the memory 107 may include any other appropriate data, such as VPN applications, firmware logs and policies, firewall policies, a security or access log, print or other reporting files, as well as others.

The illustrated enterprise server computing system 102 further includes a service layer 112. The service layer 112 provides software services to the example distributed computing system 100. The functionality of the enterprise server computing system 102 may be accessible for all service consumers using this service layer. For example, in one implementation, the client computing system 140 can utilize the service layer 112 to communicate with the change request engine 118. Software services provide reusable, defined business functionalities through a defined interface. For example, the interface may be software written in extensible markup language (XML) or other suitable language. While illustrated as an integrated component of the enterprise server computing system 102 in the example distributed computing system 100, alternative implementations may illustrate the service layer 112 as a stand-alone component in relation to other components of the example distributed computing system 100. Moreover, any or all parts of the service layer 112 may be implemented as child or sub-modules of another software module, enterprise application, or hardware module without departing from the scope of this disclosure.

The illustrated enterprise server computing system 102 further includes an application programming interface (API) 113. In some implementations, the API 113 can be used to interface between the change request engine 118 and one or more components of the enterprise server computing system 102 or other components of the example distributed computing system 100, both hardware and software. For example, in some implementations, the change request engine 118 can utilize the API 113 to communicate with the client computing system 140. The API 113 may include specifications for routines, data structures, and object classes. The API 113 may be either computer language independent or dependent and refer to a complete interface, a single function, or even a set of APIs. While illustrated as an integrated component of the enterprise server computing system 102 in the example distributed computing system 100, alternative implementations may illustrate the API 113 as a stand-alone component in relation to other components of the example distributed computing system 100. Moreover, any or all parts of the API 113 may be implemented as child or sub-modules of another software module, enterprise application, or hardware module without departing from the scope of this disclosure.

The client computing system 140 may be any computing device operable to connect to or communicate with at least the enterprise server computing system 102 using the network 130. In general, the client computing system 140 comprises a computer operable to receive, transmit, process, and store any appropriate data associated with the example distributed computing system 100. The illustrated client computing system 140 further includes an application 146. The application 146 is any type of application that allows the client computing system 140 to request and view content on the client computing system 140. In some implementations, the application 146 can be and/or include a web browser. In some implementations, the application 146 can use parameters, metadata, and other information received at launch to access a particular set of data from the enterprise server computing system 102. Once a particular application 146 is launched, a user may interactively process a task, event, or other information associated with the enterprise server computing system 102. Further, although illustrated as a single application 146, the application 146 may be implemented as multiple applications in the client computing system 140.

The illustrated client computing system 140 further includes an interface 152, a processor 144, and a memory 148. The interface 152 is used by the client computing system 140 for communicating with other systems in a distributed environment—including within the example distributed computing system 100—connected to the network 130; for example, the enterprise server computing system 102 as well as other systems communicably coupled to the network 130 (not illustrated). The interface 152 may also be consistent with the above-described interface 104 of the enterprise server computing system 102 or other interfaces within the example distributed computing system 100. The processor 144 may be consistent with the above-described processor 106 of the enterprise server computing system 102 or other processors within the example distributed computing system 100. Specifically, the processor 144 executes instructions and manipulates data to perform the operations of the client computing system 140, including the functionality required to send requests to the enterprise server computing system 102 and to receive and process responses from the enterprise server computing system 102. The memory 148 may be consistent with the above-described memory 107 of the enterprise server computing system 102 or other memories within the example distributed computing system 100 but storing objects and/or data associated with the purposes of the client computing system 140.

Further, the illustrated client computing system 140 includes a GUI 142. The GUI 142 interfaces with at least a portion of the example distributed computing system 100 for any suitable purpose, including generating a visual representation of a web browser. In particular, the GUI 142 may be used to view and navigate various web pages located both internally and externally to the enterprise server computing system 102. Generally, through the GUI 142, an enterprise server computing system 102 user is provided with an efficient and user-friendly presentation of data provided by or communicated within the example distributed computing system 100.

There may be any number of client computing systems 140 associated with, or external to, the example distributed computing system 100. For example, while the illustrated example distributed computing system 100 includes one client computing system 140 communicably coupled to the enterprise server computing system 102 using network 130, alternative implementations of the example distributed computing system 100 may include any number of client computing systems 140 suitable for the purposes of the example distributed computing system 100. Additionally, there may also be one or more client computing systems 140 external to the illustrated portion of the example distributed computing system 100 that are capable of interacting with the example distributed computing system 100 using the network 130. Moreover, while the client computing system 140 is described in terms of being used by a single user, this disclosure contemplates that many users may use one computer, or that one user may use multiple computers.

The illustrated client computing system 140 is intended to encompass any computing device such as a desktop computer, laptop/notebook computer, wireless data port, smart phone, personal data assistant (PDA), tablet computing device, one or more processors within these devices, or any other suitable processing device. For example, the client computing system 140 may comprise a computer that includes an input device, such as a keypad, touch screen, or other device that can accept user information, and an output device that conveys information associated with the operation of the enterprise server computing system 102 or the client computing system 140 itself, including digital data, visual information, or a GUI 142, as shown with respect to the client computing system 140.

The illustrated distributed computing system 100 further includes a repository 128. In some implementations, the repository 128 is an in-memory repository. The repository 128 can be a cloud-based storage medium. For example, the repository 128 can be networked online storage where data is stored on virtualized pools of storage.

With respect to the network 130, generally, the illustrated network 130 facilitates wireless or wireline communications between the components of the distributed computing system 100 (i.e., between the computing systems 102 and 140), as well as with any other local or remote computer, such as additional clients, servers, or other devices communicably coupled to network 130 but not illustrated in FIG. 1. The network 130 is illustrated as a single network in FIG. 1, but may be a continuous or discontinuous network without departing from the scope of this disclosure, so long as at least a portion of the network 130 may facilitate communications between senders and recipients. The network 130 may be all or a portion of an enterprise or secured network, while in another instance at least a portion of the network 130 may represent a connection to the Internet.

In some instances, a portion of the network 130 may be a virtual private network (VPN), such as, for example, the connection between the client computing system 140 and the enterprise server computing system 102. Further, all or a portion of the network 130 can comprise either a wireline or wireless link. Example wireless links may include 802.11a/b/g/n, 802.20, WiMax, and/or any other appropriate wireless link. In other words, the network 130 encompasses any internal or external network, networks, sub-network, or combination thereof operable to facilitate communications between various computing components inside and outside the illustrated distributed computing system 100. The network 130 may communicate, for example, Internet Protocol (IP) packets, Frame Relay frames, Asynchronous Transfer Mode (ATM) cells, voice, video, data, and other suitable information between network addresses. The network 130 may also include one or more local area networks (LANs), radio access networks (RANs), metropolitan area networks (MANs), wide area networks (WANs), all or a portion of the Internet, and/or any other communication system or systems at one or more locations.

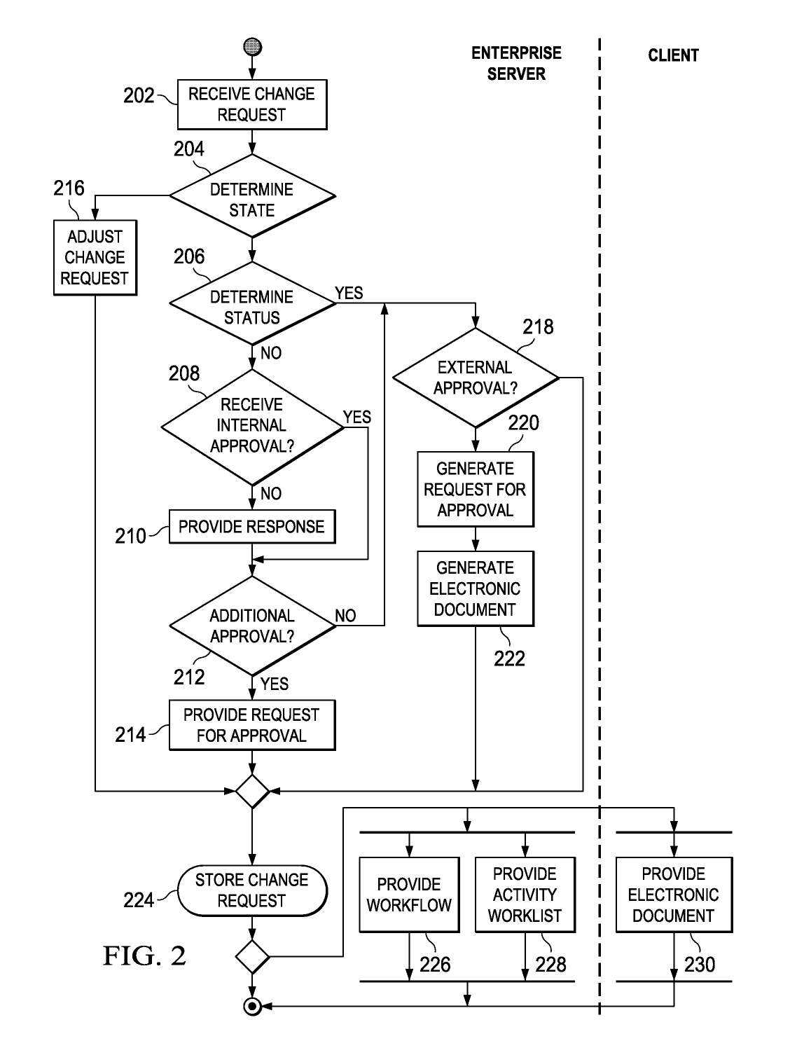

FIG. 2 is a flow chart that illustrates a method 200 for managing customer change requests. For clarity of presentation, the description that follows generally describes method 200 in the context of FIG. 1. For example, as illustrated, particular steps of the method 200 may be performed on or at an enterprise system, cloud-based system, and/or on-demand system, while other particular steps may be performed on or at a client system or on-premise system. However, method 200 may be performed, for example, by any other suitable system, environment, software, and hardware, or a combination of systems, environments, software, and hardware as appropriate.

In step 202, a change request is received that is associated with a business project of a business process. In some implementations, the change request includes one or more parameters. Specifically, the change request engine 118 receives the change request. In some examples, a user (e.g., a user of the client computing system 140) generates a change request (or edits a previously existing change request). In some examples, the user can generate the change request utilizing the application 146. The client computing system 140 can transmit the change request (and/or data related to the change request) to the enterprise server computing system 102 such that the change request engine 118 receives the change request (and/or data related to the change request).

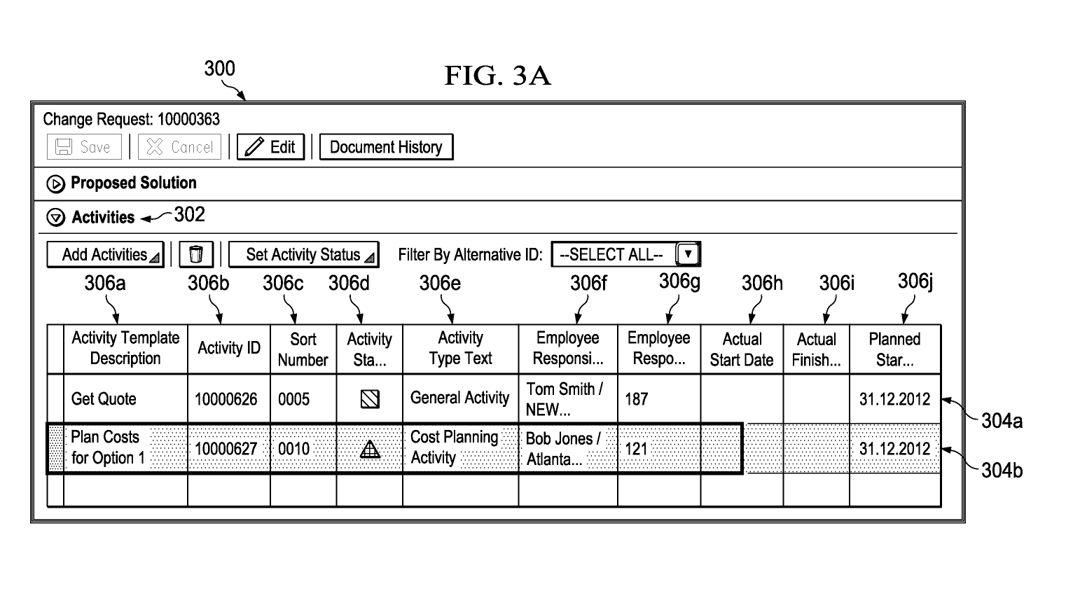

For example, FIG. 3A illustrates a graphical user interface (GUI) 300 depicting a change request (e.g., the generation of the change request by the user). The GUI 300 includes an activities portion 302 that is associated with the change request. The activities portion 302 includes one or more activities (e.g., activities 304a and 304b) associated with the change request. Each of the activities (e.g., activities 304a and 304b) includes associated data relating to one or more data fields (e.g., data fields 306a-306j). For example, the user creates (e.g., utilizing the application 146) the change request (e.g., the illustrated change request “10000363”). The activity 304a (e.g., a previous activity of the change request) is associated with a “Get Quote” of the Activity Template Description field 306a, and is a “General Activity” of the Activity Type Text field 306e. The activity 304b (e.g., a current activity of the change request) is associated with a “Plan Costs for Option 1” of the Activity Template Description field 306a, and is a “Cost Planning Activity” of the Activity Type Text field 306e.

In some examples, the user additionally associates a business project with the change request (e.g., during generation of the change request). For example, the business project can include any type of project associated with any type of business (e.g., an engineering and/or construction project). In some examples, the business project is associated a particular business enterprise (e.g., a particular engineering and/or construction firm). For example, the user generating the change request is an employee of the particular business enterprise, and thus, during creation of the change request, the change request is associated with a particular business project of the particular business enterprise.

In some implementations, the one or more parameters can be associated with the business project. For example, the one or more parameters can include a margin percentage, a change request amount (CRA), and a project status. The margin percentage can include the margin percentage that the change request alters (e.g., increases or decreases) a budget associated with the business project. The change request amount can include the amount associated with the change request. The project status can include a completion stage (e.g., blueprint, design, execution). The user provides one or more values associated with the one or more parameters (e.g., during generation of the change request). For example, the user can provide the change request amount (e.g., a monetary value associated with the change request). In some implementations, the change request engine 118 appropriately processes the change request amount, and based on the value associated with the change request amount, determines a value associated with the margin percentage (e.g., the margin percentage is based on the change request amount). In some implementations, based on the change request (e.g., as provided during generation by the user), the change request engine 118 identifies a value associated with the change request amount. For example, the change request is associated with a value of the change request amount via a table and/or a database.

In step 204, a state of the change request is determined. In some implementations, the state of the change request can be determined in response to receiving the change request. For example, the change request engine 118 determines the state of the change request.

In step 206, in response to determining that the state (of the change request) indicates that the change request is satisfactory, a status of the internal approval of the change request is determined. For example, the satisfactory state of the change request can include the change request being complete (or complete in view of a threshold) or otherwise identified to be appropriate for processing by the change request engine 118. The change request engine 118 can determine the status of the approval of the change request. For example, the status of the change request can include determining whether an internal approval of the change request has been obtained (e.g., previously obtained). In some implementations, the internal approval is associated with a particular business enterprise (e.g., internal to the particular business enterprise). For example, the internal approval can be associated with the particular business enterprise of the user that generated the change request (e.g., in step 202).

In step 208, in response to determining that the status indicates an internal approval of the change request is required (or further approval is required), it is determined whether approval from a first entity has been received. For example, the change request engine 118 can determine that an approval from the first entity (e.g., a person) associated with the particular business enterprise is required (e.g., a previous approval has not been received). In some examples, the first entity is an entity having a lowest threshold for approval (e.g., an entity having a lower priority among two or more entities). For example, the first entity can include a project manager associated with the business project.

For example, FIG. 3B illustrates the GUI 300 depicting the change request including an activity 304c associated with an internal approval of the change request. Specifically, in some examples, the approval by the first entity is provided by the activity 304c, as shown by the “Internal Approval Activity” of the Activity Template Description field 306a. The first entity can be identified by the “Employee Responsible” field 306f, described further below.

In step 210, in response to determining that approval from the first entity has not been received, the first entity provides a response to an approval request. In some examples, the first entity provides approval to the approval request. For example, the change request engine 118 receives the approval response from the first entity (e.g., via the application 146 and the client computing system 140) in response to the request for approval. In some examples, the first entity does not provide the approval (or provides a disapproval) to the approval request. In some examples, the first entity can provide a partial approval to the approval request.

In some implementations, providing the response to the approval request can further include comparing the parameters associated with business rules associated with a business enterprise (e.g., the particular business enterprise associated with the user providing the change request and/or associated with the first entity providing the response to the request for approval); determining, based on the comparison, that at least one of the parameters satisfies at least one of the business rules; in response to the determination, generating the request for approval for the change request, described in detail below.

In step 212, it is determined whether additional approval of the change request is required. For example, the change request engine 118 can determine the status of the approval of the change request in response to receiving the response to the approval request from the first entity. In some examples, the additional approval can include an additional internal approval, that is, an approval associated with the particular business enterprise.

In step 214, in response to determining that additional approval is required, one or more additional requests for approval are provided to one or more additional entities. For example, the change request engine 118 provides the additional requests for approval to the additional entities. The additional entities (e.g., persons) can be associated with the particular business enterprise (e.g., the particular business enterprise associated with the first entity). In some examples, the additional entities have a higher threshold of approval as compared to the first entity (e.g., a tiered approval threshold). In some examples, the additional entities can include management personnel, such as a vice president or a senior vice president.

In some implementations, in response to providing the one or more additional requests for approval, one or more responses are provided by the one or more additional entities in response to the one or more approval requests. In some examples, at least one of the additional entities provides approval to the additional approval request. For example, the change request engine 118 receives the additional approval response from the at least one of the additional entities (e.g., via the application 146 and the client computing system 140) in response to the request for approval. In some examples, at least one of the additional entities does not provide approval (or provides a disapproval) to the additional approval request. In some examples, the at least one of the additional entities provides a partial approval to the additional approval request.

In some examples, determining that additional approval is required can include determining that the state of the change request is unsatisfactory. For example, the unsatisfactory state of the change request can include the change request being incomplete (or incomplete in view of a threshold) or otherwise identified as not being appropriate for processing by the change request engine 118. In some examples, the unsatisfactory state can include additional approval (e.g., additional internal approval) is required for the change request.

In step 216, in response to determining that the state that the change request is unsatisfactory (e.g., at step 204), the change request is adjusted. Specifically, the change request engine 118 receives the adjustment to the change request. In some examples, the user (e.g., the user of the client computing system 140) generates the adjustment to the change request. The user can generate the adjustment to the change request utilizing the application 146. The client computing system 140 can transmit the adjustment to the change request (and/or data related to the change request) to the enterprise server computing system 102 such that the change request engine 118 receives the adjustment to the change request (and/or data related to the change request). In some implementations, the adjustment to the change request can include the user providing additional information (e.g., further clarification) regarding the change request.

In step 218, in response to determining that the status indicates that internal approval of the change request has been received, it is determined whether the status indicates that external approval of the change request is required. For example, the change request engine 118 can determine whether an external approval from one or more external entities (e.g., persons) associated with a second business enterprise differing from the particular business enterprise is required (e.g., a previous external approval has not been received or is unsatisfactory). In some examples, the second business enterprise is external to the particular business enterprise, that is, the second business enterprise is separate and distinct from the particular business enterprise. For example, the second business enterprise can include a customer of the first business enterprise (e.g., a customer employing the services of the engineering and/or construction firm).

In step 220, in response to determining that the status indicates that the external approval of the change request is required, one or more external requests for approval are generated. For example, the change request engine 118 generates the external requests for approval for the change request.

For example, FIG. 3C illustrates the GUI 300 depicting the change request including an activity 304d associated with an external approval of the change request. Specifically, in some examples, an external entity is provided by the activity 304d, as shown by the “External Approval Activity” of the Activity Template Description field 306a. The external entity can be identified by the “Employee Responsible” field 304f, described further below.

In step 222, an electronic document is generated based on the change request. Specifically, the change request engine 118 creates the electronic document (not shown) based on the change request. In some examples, the electronic document includes details associated with the change request (e.g., the parameters). For example, the details associated with the change request are added as an attachment to the electronic document. In some examples, the electronic document includes the external request for approval. In some examples, the electronic document is of a portable document format (e.g., “pdf”).

In step 224, the change request is stored (e.g., stored in memory). For example, the change request engine 118 stores the change request in a database, or a table, associated with the memory 107, the repository 128, or both. In some implementations, the change request is stored in response to providing the one or more additional requests for approval to the one or more additional entities (e.g., in step 214). In some implementations, the change request is stored in response to adjusting the change request (e.g., in step 216). In some implementations, the change request is stored in response to generating the electronic document based on the change request (e.g., in step 222).

In some implementations, in addition to storing the change request, a current state of the change request is also stored. For example, the current state of the change request can include an approval state of the change request (e.g., approved or non-approved). In some examples, the approval state can include an internal approval state and/or an external approval state of the change request. In some examples, the current state of the change request can include whether the change request is original (e.g., as received in step 202) or adjusted (e.g., in step 216).

In step 226, a workflow is provided to one or more entities associated with the particular business enterprise. For example, the change request engine 118 provides the workflow to the entities associated with the particular business enterprise (e.g., entities employed by the particular business enterprise). In some examples, the workflow includes a sequence of approvals required from the entities associated with the particular business enterprise (e.g., the order of entities to provide approval of the change request). In some examples, the workflow is specific to the particular business enterprise. In some examples, the workflow is provided to the one or more entities in response to storing the change request (e.g., in step 224).

In step 228, an activity worklist is provided to one or more entities associated with the particular business enterprise. For example, the change request engine 118 provides the worklist to the entities associated with the particular business enterprise (e.g., entities employed by the particular business enterprise). In some examples, the worklist includes a set of tasks that are performed by the entities associated with the particular business enterprise for approval of the change request. For example, the tasks of the worklist can include a “get related documents” task, a “get material quotes” task, a “cost planning” task, and an “update required” task. In some examples, the worklist is provided to the one or more entities in an electronic mail (e-mail). In some implementations, providing the worklist is preformed concurrently with providing the workflow (e.g., step 226). In some examples, the worklist is provided to the one or more entities in response to storing the change request (e.g., in step 224).

In step 230, the electronic document is provided to one or more external entities. For example, the change request engine 118 provides the electronic document (e.g., including the requests for approval) to the external entities. The enterprise server computing system 140 can transmit the electronic document to the external entities via a computing system (not shown) associated with the external entities that is in communication with the network 130.

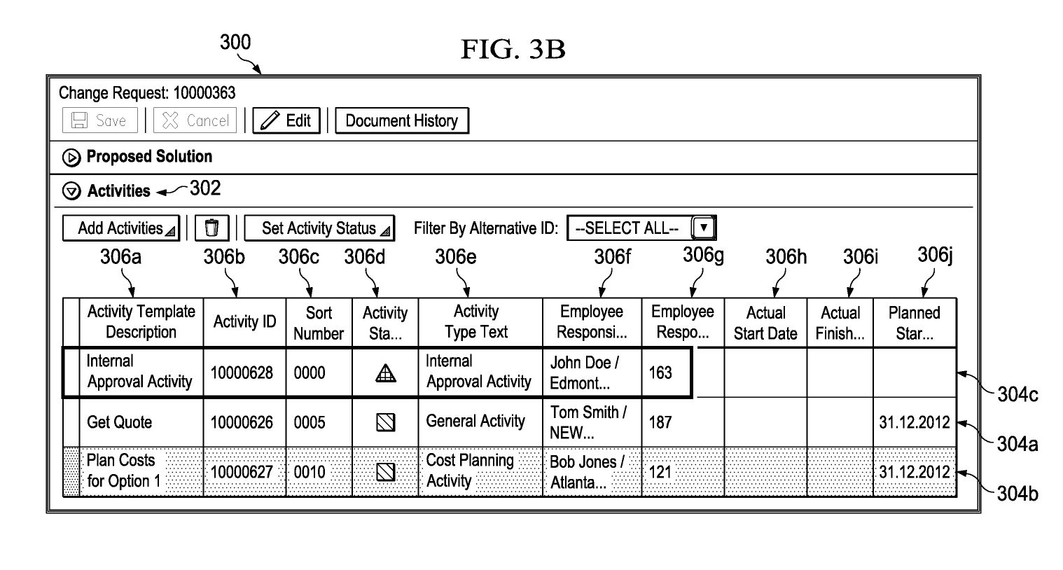

FIG. 4 is a flow chart that illustrates a method 400 for managing customer change requests. For clarity of presentation, the description that follows generally describes method 400 in the context of FIG. 1. However, method 400 may be performed, for example, by any other suitable system, environment, software, and hardware, or a combination of systems, environments, software, and hardware as appropriate.

In step 402, a change request is received that is associated with a business project of a business enterprise. Further, the change request includes one or more parameters. Similar to that mentioned above with respect to step 202 of FIG. 2, the change request engine 118 receives the change request. In some examples, a user (e.g., a user of the client computing system 140) generates a change request (or edits a previously existing change request). The user can generate the change request utilizing the application 146. The client computing system 140 can transmit the change request (and/or data related to the change request) to the enterprise server computing system 102 such that the change request engine 118 receives the change request (and/or data related to the change request).

In step 404, the one or more parameters are compared with one or more business rules that are associated with the business enterprise. Specifically, the change request engine 118 compares the parameters that are associated with the received change request (e.g., in step 402) with business rules that are associated with the particular business enterprise (e.g., the particular business enterprise that is associated with the user providing the change request). In some examples, the business rules can include any rules that define or constrain some aspect of business associated with the particular business enterprise. For example, the business rules can be associated with thresholds relating to margin percentage, change request amount, and project status. In some examples, the business rules are specific to the change request (e.g., based on the change request). In some examples, the business rules are predefined (e.g., by the particular business enterprise). In some examples, the business rules are specific to the particular business enterprise (e.g., based on the particular business enterprise).

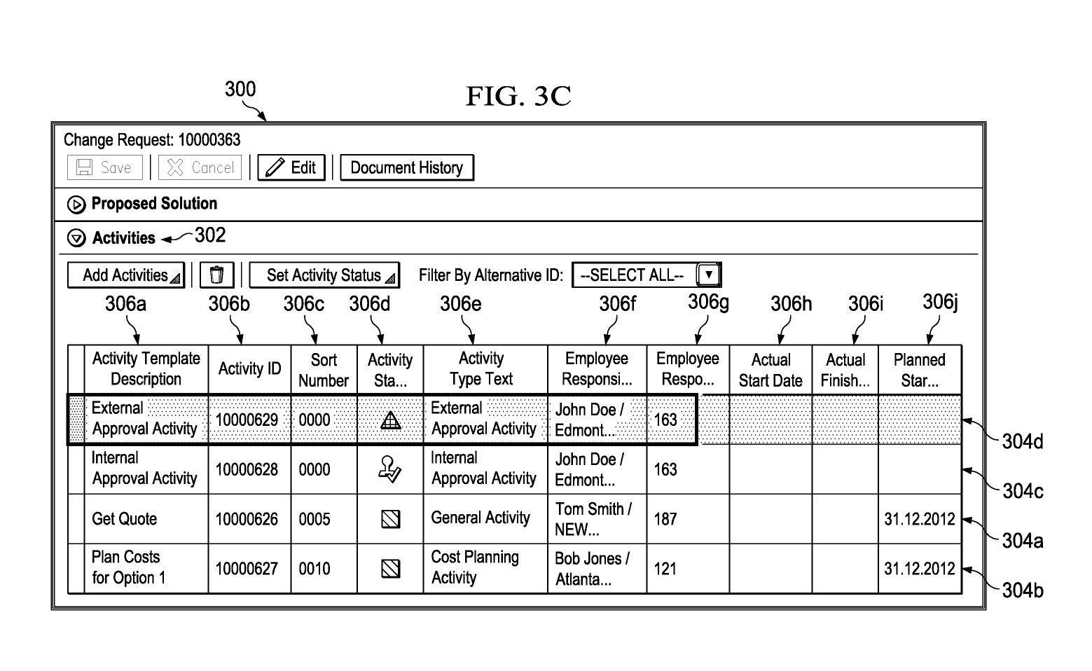

In step 406, based on the comparison (of the one or more parameters with the one or more business rules), it is determined that at least one of the one or more parameters satisfies at least one of the one or more business rules. Specifically, the change request engine 118 determines that at least one parameter satisfies one of the business rules. For example, FIG. 5 illustrates an “Approval” matrix 502 employed to compare the parameters (of the change request) with the business rules (of the particular business enterprise) and determine whether at least one parameter satisfies at least one business rule. As illustrated, the matrix 502 includes business rules 504a, 504b, 504c; however, any number of business rules can be associated with the matrix 502 (e.g., as determined by the particular business enterprise and/or the change request).

In some examples, the business rule 504a is associated with margin percentage thresholds; the business rule 504b is associated with change request amount thresholds; and the business rule 504 is associated with project status thresholds. The change request engine 118 compares the parameters associated with the change request with each of the business rules 504a, 504b, 504c, and based on the comparison, determines whether at least one of the parameters satisfies at least one of the business rules.

In some examples, the parameter associated with the margin percentage of the change request is compared with the business rule 504a. Based on the comparison, the change request engine 118 determines which threshold of the business rule 504a applies to the parameter. For example, the business rule 504a has thresholds relating to the margin percentage (e.g., the value of the margin percentage) being less than or equal to a first amount (e.g., 2%); greater than the first amount (e.g., 2%) and less than a second amount (e.g., 5%); and greater than the second amount (e.g., 5%). In some examples, the parameter associated with the change request amount of the change request is compared with the business rule 504b.

Based on the comparison, the change request engine 118 determines which threshold of the business rule 504b applies to the parameter. For example, the business rule 504b has thresholds relating to the change request amount (e.g., the value of the change request amount) being less than or equal to a first amount (e.g., $10,000); greater than the first amount (e.g., $10,000) and less than a second amount (e.g., $30,000); and greater than the second amount (e.g., $30,000). In some examples, the parameter associated with the project status of the change request is compared with the business rule 504c.

Based on the comparison, the change request engine 118 determines which threshold of the business rule 504c applies to the parameter. For example, the business rule 504c has thresholds relating to the status of the project being a first status (e.g., blueprint/design), a second status (e.g., design/execution), and a third status (e.g., any).

In step 408, in response to the determination (that at least one of the one or more parameters satisfies at least one of the one or more business rules), one or more requests for approval for the change request are generated. Specifically, the change request engine 118 generates the requests for approval for internal approval of the change request. In some examples, internal approval of the change request can include approval from one or more entities associated with the particular business enterprise (e.g., the business enterprise of the business project of the change request received in step 402).

In step 410, one or more approval responses are received from one or more entities associated with the business enterprise. Particularly, the one or more approval response are received in response to the one more requests for approval. Specifically, the change request engine 118 receives the approval responses from internal entities (e.g., persons associated with the particular business enterprise) in response to the requests for approval.

In step 412, in response to receiving the one or more approval responses, a property associated with the business project is updated. Specifically, the change request engine 118 updates the property (or properties) associated with the business project. For example, the property can include a monetary budget, a time budget, or both, associated with the business project; however, other properties can be associated with the business project and updated accordingly. Thus, based on the change request (e.g., the approval of the change request), the property associated with the business project is updated as appropriate. For example, the monetary budget of the business project is updated based on the value of the change request amount associated with the change request (e.g., updated to include the value of the change request amount).

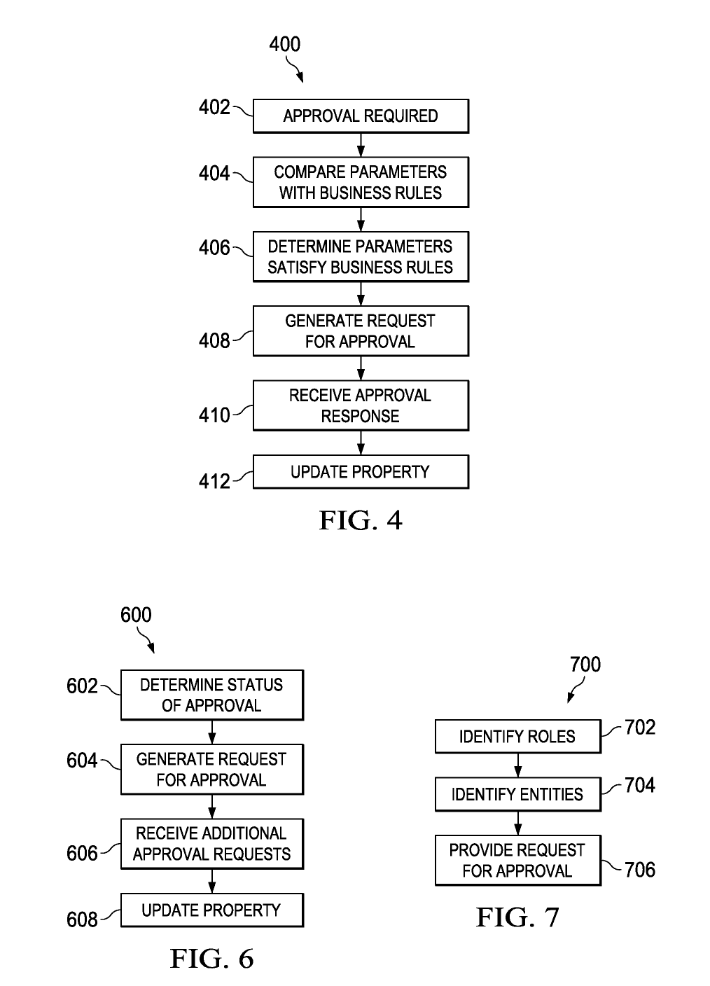

FIG. 6 is a flow chart that illustrates a method 600 for managing external approval of customer change requests. For clarity of presentation, the description that follows generally describes method 600 in the context of FIG. 1. However, method 600 may be performed, for example, by any other suitable system, environment, software, and hardware, or a combination of systems, environments, software, and hardware as appropriate.

In step 602, a status of approval of the change request from one or more entities associated with a second, differing business enterprise is determined. Specifically, the change request engine 118 determines the status of an external approval of the change request from entities associated with the second business enterprise. In some examples, the second business enterprise is external to the particular business enterprise, that is, the second business enterprise is separate and distinct from the particular business enterprise.

In step 604, based on determining that the status indicates that the approval (e.g., external approval) is required, generating one or more additional requests for approval for the change request. Specifically, the change request engine 118 generates the additional requests for approval for the change request for the external entities associated with the second business enterprise. In some implementations, the additional requests for approval (e.g., external approval) are generated in coordination with obtaining the internal approval (e.g., method 400). In some implementations, the additional requests for approval (e.g., external approval) are generated concurrently with obtaining the internal approval (e.g., method 400). In some implementations, the additional requests for approval (e.g., external approval) are generated after receiving the one or more internal approval responses (e.g., in step 412).

In step 606, one or more additional approval responses are received from one or more entities associated with the second, differing business enterprise. Particularly, the one or more additional approval response are received in response to the additional request for approval. Specifically, the change request engine 118 receives the additional approval responses from external entities (e.g., users associated with the second business enterprise) in response to the additional requests for approval.

In step 608, in response to receiving the one or more approval responses (e.g., external approval responses), a property associated with the business project is updated. Specifically, the change request engine 118 updates the property (or properties) associated with the business project. In some implementations, the property is updated in coordination with updating the property based on the internal approval (e.g., in step 412).

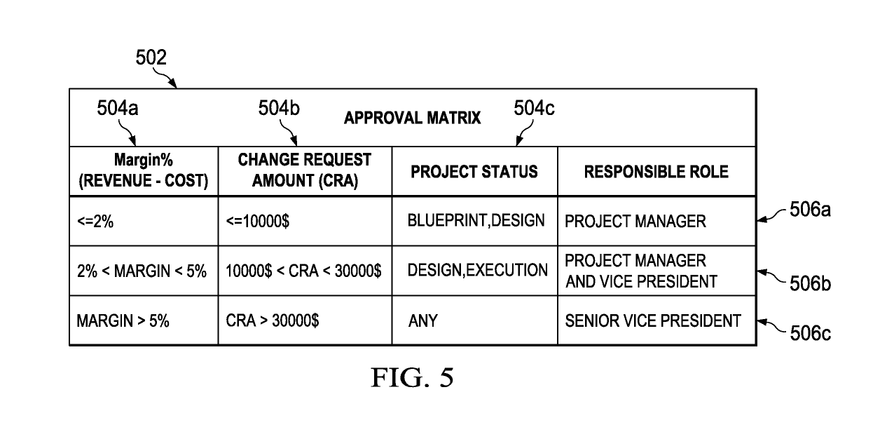

FIG. 7 is a flow chart that illustrates a method 700 for generating requests for approval. For clarity of presentation, the description that follows generally describes method 700 in the context of FIG. 1. However, method 700 may be performed, for example, by any other suitable system, environment, software, and hardware, or a combination of systems, environments, software, and hardware as appropriate.

In step 702, one or more roles are identified that are based on the comparison (of the one or more parameters with the one or more business rules in step 404). Specifically, the change request engine 118 identifies roles (e.g., project-related roles or project-related employment jobs) that are based on the comparison of the parameters with the business rules. For example, the matrix 502 of FIG. 5 further includes associated roles (e.g., “responsible roles”) 506a, 506b, 506c associated with the business rules 504a, 504b, 504c. Specifically, the change request engine 118 identifies the roles based upon the comparison of the parameters of the change request and the business rules 504a, 504b, 504c (e.g., in step 404) and determining that at least one of the parameters satisfies at least one of the business rules 504a, 504b, 504c (e.g., in step 406). For example, the role 506a is associated with a project manager role; the role 506b is associated with a project manager role and a vice president role; and the role 506c is associated with a senior vice president role.

To that end, based upon which parameters (of the change request) satisfy which business rules 504a, 504b, 504c, the change request engine 118 identifies one of the roles 506a, 506b, 506c. For example, for a change request including parameters satisfying the first thresholds of the business rules 504a, 504b, 506c (e.g., less than 2% margin change; change request amount less than $10,000; and project status of blueprint/design), the change request engine 118 identifies the role 504a of project manager. In some examples, one or more of the business rules 504a, 504b, 504c are weighted such that when parameters of a change request satisfying differing thresholds of the business rules 504a, 504b, 504c, the weight of the business rules 504a, 504b, 504c are evaluated to determine the appropriate person. For example, for a change request including parameters satisfying the first threshold of the business rule 504a (e.g., less than 2% margin change) and the third threshold of the business rule 506b (e.g., change request amount greater than $30,000), the change request engine 118 determines the business rule 506b supersedes the business rule 504a, and thus, identifies the senior vice president as the appropriate person for approval.

In step 704, one or more entities are identified that are associated with the one or more roles (e.g., the roles identified in step 702). Specifically, the change request engine 118 identifies the entities (e.g., internal or external entities) associated with the roles. For example, FIG. 3B illustrates the GUI 300 depicting that the field 306f of activity 304c being associated with an entity (e.g., “John Doe”). In some examples, field 306f further includes information associated with the identified entity, such as an office location (of the particular business enterprise). In some examples, field 306g is further associated with the identified role, including a code (e.g., numerical) associated with the identified entity. For example, the code “163” (e.g., employee code) is associated with the identified entity.

In step 706, the one or more requests for approval are provided to the one or more entities. Specifically, the change request engine 118 provides the requests for approval to the entities. For example, in response to generating the one or more requests for approval for the change request (e.g., in step 408), the requests for approval are provided to the entities. Additionally, the approval responses are received from the entities (e.g., in step 410) in response to providing the request for approval to the entities. In some examples, the enterprise server computing system 140 can transmit the request for approval to the client computing system 140 such that the entities receives the request for approval.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example Linux, UNIX, Windows, Mac OS, Android, iOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a central processing unit (CPU), a FPGA (field programmable gate array), or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN), a wide area network (WAN), e.g., the Internet, and a wireless local area network (WLAN).

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order (e.g., FIGS. 2, 4, 6, and 7), this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A computer-implemented method of managing customer change requests, the method comprising:
receiving a change request associated with a business project of a business enterprise, the change request including one or more parameters;
comparing the one or more parameters with one or more business rules associated with the business enterprise;
based on the comparison, determining that at least one of the one or more of the parameters satisfies at least one of the one or more business rules;
in response to the determination, generating one or more requests for approval for the change request;
receiving one or more approval responses from one or more entities associated with the business enterprise in response to the one or more requests for approval; and
in response to receiving the one or more approval responses, updating a property associated with the business project.

2. The method of claim 1, wherein the business enterprise is a first business enterprise, the method further comprising:
determining a status of an approval of the change request from one or more entities associated with a second business enterprise that is different than the first business enterprise;
based on determining that the status indicates that the approval is required, generating one or more additional requests for approval for the change request;
receiving one or more additional approval responses from one or more entities associated with the second business enterprise in response to the one or more additional requests for approval; and
in response to receiving the one or more additional approval responses, updating the property associated with the business project.

3. The method of claim 1, wherein the one or more parameters include margin percentage, change request amount, and project status.

4. The method of claim 1, wherein generating the one or more requests for approval further comprises:
identifying one or more roles based on the comparison, the roles associated with the business enterprise;
identifying the one or more entities associated with the one or more roles; and
providing the one or more requests for approval to the one or more entities.

5. The method of claim 1, further comprising:
determining a status of an approval of the change request; and
in response to determining that the status indicates that the approval is required, comparing the one or more parameters with one or more business rules associated with the business enterprise.

6. The method of claim 5, further comprising:
determining a state of the change request;
in response to determining the state of the change request, performing at least one of:
determining the status of the approval of the change request based on a determination that the change request is satisfactory; or
adjusting the change request based on a determination that the change request is unsatisfactory.

7. The method of claim 1, wherein the property includes a monetary budget associated with the business project.

8. A computer storage medium encoded with a computer program, the program comprising instructions that when executed by one or more computers cause the one or more computers to perform operations comprising:
receiving a change request associated with a business project of a business enterprise, the change request including one or more parameters;
comparing the one or more parameters with one or more business rules associated with the business enterprise;
based on the comparison, determining that at least one of the one or more of the parameters satisfies at least one of the one or more business rules;
in response to the determination, generating one or more requests for approval for the change request;
receiving one or more approval responses from one or more entities associated with the business enterprise in response to the one or more requests for approval; and
in response to receiving the one or more approval responses, updating a property associated with the business project.

9. The computer storage medium of claim 8, wherein the business enterprise is a first business enterprise, the operations further comprising:
determining a status of an approval of the change request from one or more entities associated with a second business enterprise that is different than the first business enterprise;
based on determining that the status indicates that the approval is required, generating one or more additional requests for approval for the change request;
receiving one or more additional approval responses from one or more entities associated with the second business enterprise in response to the one or more additional requests for approval; and
in response to receiving the one or more additional approval responses, updating the property associated with the business project.

10. The computer storage medium of claim 8, wherein the one or more parameters include margin percentage, change request amount, and project status.

11. The computer storage medium of claim 8, wherein generating the one or more requests for approval further comprises:
identifying one or more roles based on the comparison, the roles associated with the business enterprise;
identifying the one or more entities associated with the one or more roles; and
providing the one or more requests for approval to the one or more entities.

12. The computer storage medium of claim 8, the operations further comprising:
determining a status of an approval of the change request; and
in response to determining that the status indicates that the approval is required, comparing the one or more parameters with one or more business rules associated with the business enterprise.

13. The computer storage medium of claim 12, the operations further comprising:
determining a state of the change request;
in response to determining the state of the change request, performing at least one of:
determining the status of the approval of the change request based on a determination that the change request is satisfactory; or
adjusting the change request based on a determination that the change request is unsatisfactory.

14. The computer storage medium of claim 8, wherein the property includes a monetary budget associated with the business project.

15. A system of one or more computers configured to perform operations comprising:
receiving a change request associated with a business project of a business enterprise, the change request including one or more parameters;
comparing the one or more parameters with one or more business rules associated with the business enterprise;
based on the comparison, determining that at least one of the one or more of the parameters satisfies at least one of the one or more business rules;
in response to the determination, generating one or more requests for approval for the change request;
receiving one or more approval responses from one or more entities associated with the business enterprise in response to the one or more requests for approval; and
in response to receiving the one or more approval responses, updating a property associated with the business project.

16. The system of claim 15, wherein the business enterprise is a first business enterprise, the operations further comprising:
determining a status of an approval of the change request from one or more entities associated with a second business enterprise that is different than the first business enterprise;
based on determining that the status indicates that the approval is required, generating one or more additional requests for approval for the change request;
receiving one or more additional approval responses from one or more entities associated with the second business enterprise in response to the one or more additional requests for approval; and
in response to receiving the one or more additional approval responses, updating the property associated with the business project.

17. The system of claim 15, wherein the one or more parameters include margin percentage, change request amount, and project status.

18. The system of claim 15, wherein generating the one or more requests for approval further comprises:
identifying one or more roles based on the comparison, the roles associated with the business enterprise;
identifying the one or more entities associated with the one or more roles; and
providing the one or more requests for approval to the one or more entities.

19. The system of claim 15, the operations further comprising:
determining a status of an approval of the change request; and
in response to determining that the status indicates that the approval is required, comparing the one or more parameters with one or more business rules associated with the business enterprise.

20. The system of claim 19, the operations further comprising:
determining a state of the change request;
in response to determining the state of the change request, performing at least one of:
determining the status of the approval of the change request based on a determination that the change request is satisfactory; or
adjusting the change request based on a determination that the change request is unsatisfactory.

21. The system of claim 15, wherein the property includes a monetary budget associated with the business project.

22. A computer-implemented method of managing customer change requests, the method comprising:
receiving a change request associated with a business project of a business enterprise, the change request including one or more parameters, the parameters comprising at least one of margin percentage, change request amount, or project status;
comparing the one or more parameters with one or more business rules associated with the business enterprise;
based on the comparison, determining that at least one of the one or more of the parameters satisfies at least one of the one or more business rules;
in response to the determination, generating one or more requests for approval for the change request to provide to one or more entities of the business enterprise that are associated with particular roles of the enterprise;
receiving one or more approval responses from one or more entities associated with the business enterprise in response to the one or more requests for approval;
determining a status of an approval of the change request;
in response to determining that the status indicates that the approval is required, comparing the one or more parameters with one or more business rules associated with the business enterprise; and
in response to receiving the one or more approval responses, updating a property associated with the business project.
